(19) United States
(12) Patent Application Publication
(10) Pub. No.: US 2026/0133909 A1
(43) Pub. Date: May 14, 2026

(54) COHERENT TRAFFIC ACCELERATION FOR A DIRECTORY-BASED MULTI-CORE ELECTRONIC SYSTEM

(71) Applicant: ARTERIS, INC., Campbell, CA (US)

(72) Inventors: Eric TAYLOR, Austin, TX (US); Laurent MOLL, San Jose, CA (US); Hao LUAN, Plano, TX (US)

(73) Assignee: ARTERIS, INC., Campbell, CA (US)

(21) Appl. No.: 18/901,002

(22) Filed: Sep. 30, 2024

(51) Int. Cl. G06F 12/0817

(52) U.S. Cl. CPC G06F 12/0828; G06F 2212/621

(57) ABSTRACT

An electronic system includes an interconnect for a plurality of cores. A directory-based cache coherence method for the electronic system includes receiving a request transaction including a plurality of writes; sending a request for ownership of a window of cache lines corresponding to the writes; granting ownership to the cache lines without regard for order; and committing the write that is oldest once ownership has been granted to its corresponding cache line.

### TECHNICAL FIELD

The present technology is in the field of multi-core electronic systems.

### BACKGROUND

A multi-core electronic system may include multiple processors or cores having local caches that communicate with shared memory. Data is transferred to and from the shared memory in blocks of fixed size, called “cache lines” or “cache blocks.”

Cache coherence is a protocol that maintains consistency of data stored in shared memory. When multiple cores are accessing and modifying the same memory locations in shared memory, cache coherence ensures that any changes made by one core are immediately visible to all other cores, thereby preventing data inconsistencies.

A directory-based protocol is commonly used to ensure cache coherency. A directory acts as a central control through which permission is requested to store data in shared memory. To write a cache line to shared memory, a coherent write may be sent down to the directory, which places the cache line in the correct state and returns a status. The status indicates that the cache line is owned. The cache line is written to shared memory. The ownership and the data transfer are performed under the same monolithic coherent write flow.

### SUMMARY

In accordance with various embodiments and aspects herein, an electronic system includes an interconnect for a plurality of cores. A directory-based cache coherence method for the electronic system includes receiving a request transaction including a plurality of writes, sending a request for ownership of a window of cache lines corresponding to the writes, granting ownership to the cache lines without regard for order, and committing the write that is oldest once ownership has been granted to its corresponding cache line.

In accordance with various embodiments and aspects herein, an electronic system includes a plurality of initiators, an interconnect, and a plurality of interface units. Each interface unit is configured to receive request transactions from a corresponding initiator and send requests for ownership of windows of cache lines corresponding to writes in the request transactions. The electronic system further includes a directory for maintaining cache coherence. The directory is configured to grant ownership to the cache lines. Each write is committed when it is oldest and when its cache line has acquired ownership.

In accordance with various embodiments and aspects herein, a network-on-chip includes a plurality of initiator network interface units and a directory. Each initiator interface is configured to receive request transactions and send requests for ownership of windows of cache lines corresponding to writes in the request transactions. The directory is configured to grant ownership to the cache lines without regard for order. Each write that is oldest and whose cache line has acquired ownership is committed.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 shows a multi-core electronic system including a network-on-chip in accordance with various aspects and embodiments herein.

FIG. 2 shows a directory-based method for cache coherence in accordance with various aspects and embodiments herein.

FIG. 3 shows a plurality of writes managed by a directory in accordance with various aspects and embodiments herein.

FIG. 4 shows a directory-based method for cache coherence in accordance with various aspects and embodiments herein.

FIG. 5 shows a plurality of writes managed by a directory in accordance with various aspects and embodiments herein.

FIG. 6 shows a multi-core-electronic system in accordance with various aspects and embodiments herein.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

The terms “source,” “master,” and “initiator” are used interchangeably herein. The terms “sink,” “slave,” and “target” are used interchangeably herein.

A “transaction” may refer to a request transaction or a response transaction. A transaction may contain one or more destination addresses for one or more components the transaction is sent to. The address may include the address of a sub-component (e.g., an individual register within an array of registers, internal memory, etc.).

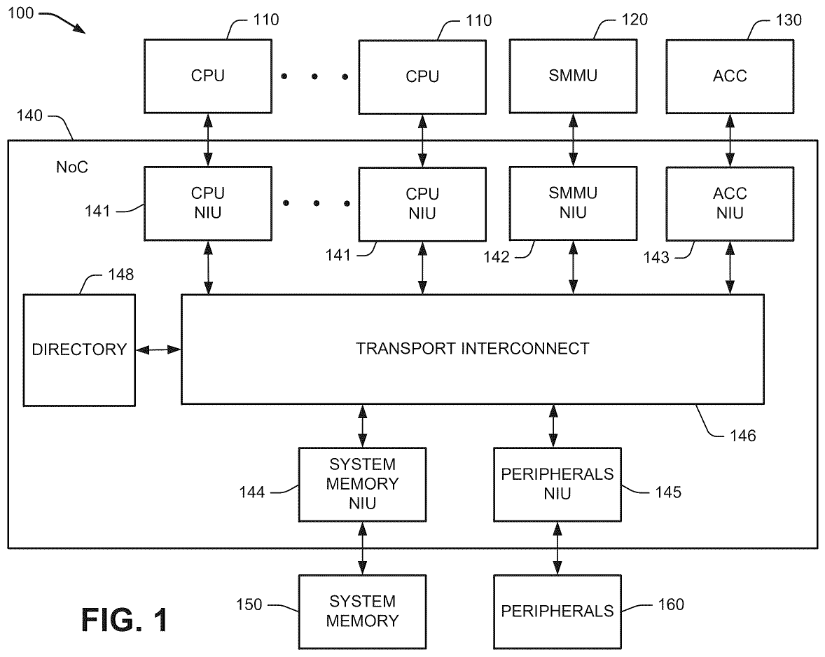

Reference is made to FIG. 1, which illustrates an electronic system 100 including a plurality of cores. The cores include initiators such as central processing units (CPUs) 110, a system management memory unit (SMMU) 120, and an accelerator 130. The CPUs 110 have caches. The SMMU 120 typically has a cache and a translation lookaside buffer (TLB). The accelerator 130 may or may not have a cache. The cores also include targets such as system memory 150 and peripheral devices 160.

The electronic system 100 further includes a network-on-chip (NoC) 140. The NoC 140 sends request transactions from an initiator to one or more targets using industry-standard protocols. A request transaction includes an address of the target. The NoC 140 decodes the address and transports the request transaction. The target handles the request transaction and sends a response transaction, which is transported back to the initiator via the NoC 140.

The NoC 140 includes a plurality of network interface units (NIUs) 141-145 and a transport interconnect 146. Each initiator is coupled to the transport interconnect 146 via a corresponding NIU. Thus, each CPU 110 is coupled to the transport interconnect 146 via a CPU NIU 141, the SMMU 120 is coupled to the transport interconnect 146 via an SMMU NIU 142, and the accelerator 130 is coupled to the transport interconnect 146 via an accelerator NIU 143.

Each target is coupled to the transport interconnect 146 via a corresponding NIU. Thus, the system memory 150 is coupled to the transport interconnect 146 via a system memory NIU unit 144, and the peripheral devices 160 are coupled to the transport interconnect 146 via a peripherals NIU 145.

Each NIU 141-145 is configured to convert the protocol used by its corresponding core into a transport protocol used inside the NoC 140. The transport protocol is typically based on the transmission of packets. An additional function of the NIUs will be discussed below.

The transport interconnect 146 transports packets between the NIUs. The transport interconnect 146 includes switches, adapters, and buffers. Switches may be used to route flows of traffic between source and destinations. Adapters may be used to deal with various conversions between data width, clock and power domains. Buffers may be used to insert pipelining elements to span long distances, or to store packets to deal with rate adaptation between fast senders and slow receivers or vice-versa.

The NoC 140 is cache-coherent, that is, the NoC 140 ensures cache coherence across the electronic system 100 by maintaining consistency of shared data stored in local caches of the CPUs 110 and data stored in the system memory 150. When multiple cores are accessing and modifying the same memory locations, the coherent NoC 140 ensures that any changes made by one core are immediately visible to all other cores, thereby preventing data inconsistencies.

The NoC 140 implements a cache-coherence protocol. One example of such a protocol is MOESI (Modified, Owned, Exclusive, Shared, Invalid).

The NoC 140 includes a directory 148, which is a dedicated processor (e.g., memory and a state machine) that facilitates the communication between different cores and guarantees that its coherence protocol is working properly along all of the communicating cores. In some embodiments, the directory 148 keeps track of the state of a certain number of cache lines (including a cache coherence state of each cache line), and which cores are sharing a given cache line at a given time. For other cache lines, the directory doesn't keep track of any states and instead snoops out all of the cores to determine the states of the other cache lines. In other embodiments, the directory doesn't store any states and instead orchestrates the communication to the cores to determine the states of the cache lines.

A cache line or cache block refers to a data block of fixed size. The block can reside in cacheable or non-cacheable region. Thus, a cache line is not limited to a data block inside a cacheable region. In FIG. 1, for example, cache lines are inside the system memory 150.

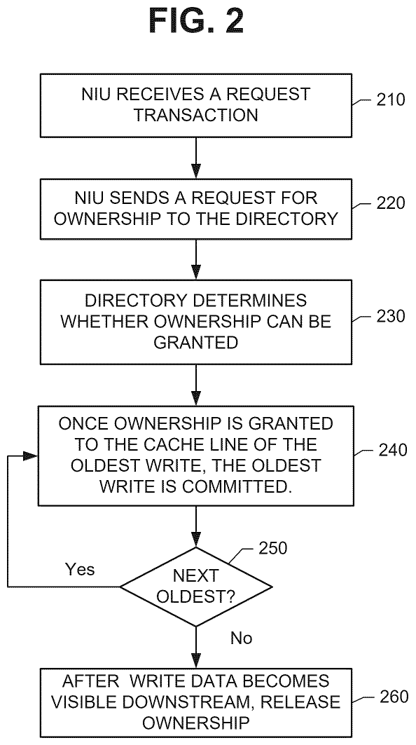

Reference is made to FIG. 2, which illustrates a directory based method of processing a request transaction. At block 210, an NIU receives a request transaction from its corresponding core. The request transaction may include one or more writes. Each write identifies a target address. The writes and corresponding write data are buffered in the NIU.

The request transaction may have strongly ordered requirements. If the incoming writes need to be strongly ordered, then the writes will be committed in the same order they are received.

At block 220, the NIU unit sends a request for ownership to the directory 148. The request specifies ownership of a window of cache lines identified by the writes in the request transaction. The window may cover one or more cache lines. The ownership of the window may be requested by generating a cache maintenance operation (CMO) for each cache line and sending each CMO to the directory 148. The CMO is a dataless operation for placing a cache line in a specific state (e.g., owned). Each CMO specifies a target address, and a cache line is derived from the target address.

The directory 148 may have a directory transactions table for keeping track of the status of the cache lines. Entries in the table indicate the status of the cache lines.

At block 230, the directory 148 determines whether ownership can be granted to each of the cache lines. The ownership will not necessarily be granted in the same order as the writes. For ownership to be granted, a series of events occurs. First, the CMO is entered in the directory transaction table. This event occurs if the transaction table doesn't have an outstanding transactions to that cache line. Once the CMO has been entered, the directory 148 sends snoops to all of the appropriate NIUs. The directory 148 waits to receive responses before the CMO can make progress. Once the responses are received, and no transactions are outstanding, the directory 148 grants the state that was requested (in this case, owned).

At block 240, once ownership is granted to the cache line of the oldest write, the oldest write is committed. A write becomes oldest once all of the earlier writes have been sent downstream.

The write may be a non-coherent write such as a write-back. The write-back carries data. In a write-back policy, data is written only to the cache, and data in the cache is written back to memory at a later time (when a cache line is evicted). Since the NIU doesn't have a cache, its flow is analogous to a write-back policy.

At block 250 the next oldest write in the order becomes the oldest, and control is returned to block 240. This continues until all of the writes have been committed.

At block 260, after all of the writes have been completed downstream, write data will be visible downstream. At this point, the ownership of the window of cache lines may be released.

Advantageously, the method of FIG. 2 decouples ownership acquisition from the writes. Cache coherence can be achieved with ownership and non-coherent write commands (e.g., CMOs and write-backs) that are lightweight in that they requires less messaging than a full Coherent Write. The CMO is dataless, and the write-back doesn't communicate with the directory 148. This enables the NIU to get quicker control over a cache line so it can control ordering. The quicker the NIU can control ordering, the faster it can stream data downstream to the targets.

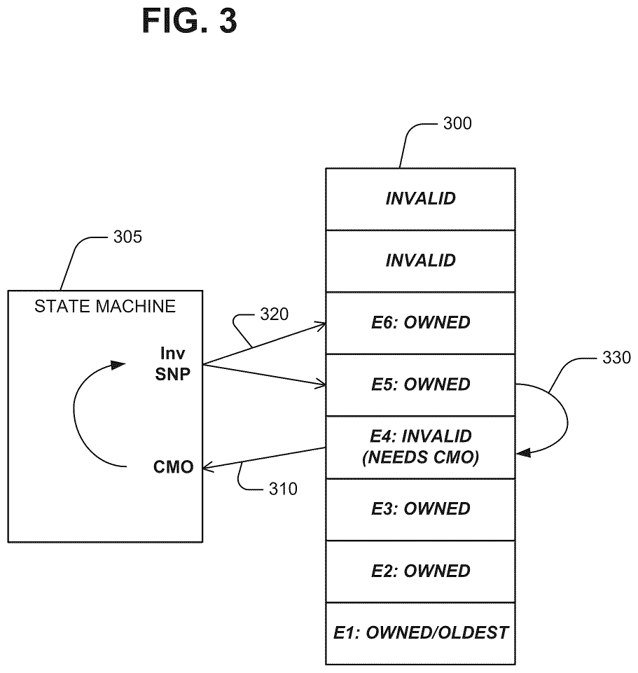

Deadlock might occur. Consider the example in FIG. 3. The directory 148 includes a table 300 and a state machine 305. The table 300 has entries E1, E2, E3, E4, E5 and E6 for corresponding first, second, third, fourth, fifth and sixth cache lines. Each entry indicates the state of its corresponding cache line (e.g., invalid, owned). Each entry may include additional information, such as whether its write has completed. The entries E1-E6 are placed in the order in which their corresponding writes were received (entry E1, which is at the bottom of the table 300, is oldest). If the electronic system 100 is strongly ordered, the writes are committed in the same order they were received. Thus, the oldest (first) write is committed first, the second write is committed next, and so on until the sixth write is committed.

Ownership is not granted in order. For example, FIG. 3 shows that ownership has been granted to the first, second, third, fifth and sixth cache lines, but not the fourth cache line. The fourth cache line is still invalid and needs a CMO to gain ownership (310). As a result, writes for the fifth and sixth cache lines cannot be committed until the write of the fourth cache line is committed.

A snoop might occur before ownership of the fourth cache line is granted. A snoop is essentially any outside message attempting to get information about the cache lines. If the cache lines are snooped, then the CMO cannot progress until the snoops progress (320). Typically snoops are responded to. However, the snoops cannot progress until the write of the fourth cache line makes progress and that cannot occur until the CMO makes progress (330). And the writes of the fifth and sixth cache lines cannot be committed until the write of the fourth ache line is committed. Hence the deadlock.

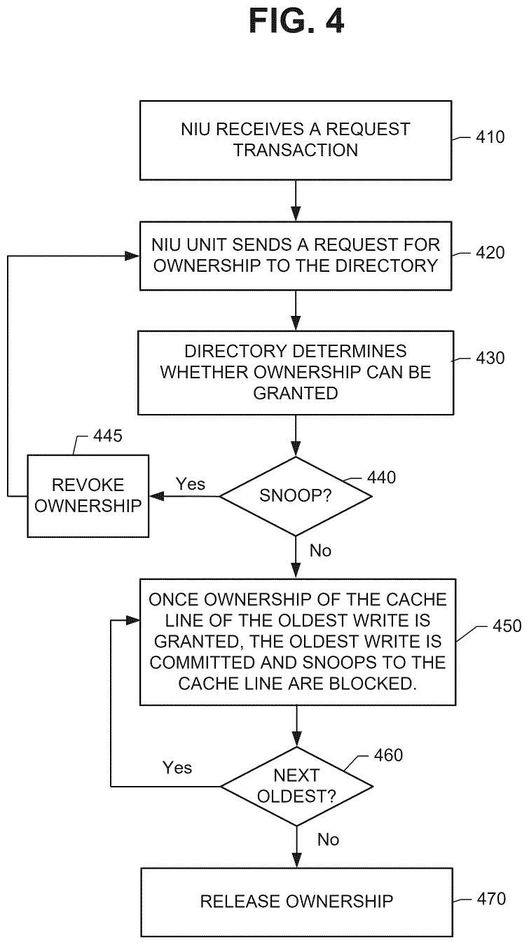

The method of FIG. 4 avoids deadlocks. As above, an NIU receives a request transaction from its corresponding core (block 410), a request for ownership is made for the cache lines corresponding to the writes in the request transaction (block 420), and the directory determines whether ownership can be granted (block 430), and grants ownership. Once the cache line of the oldest write has ownership, the oldest write is committed (block 450). This continues until all writes are committed (blocks 460) or until a cache line is snooped (block 440).

In a typical grant of ownership, snoops from other cores are blocked. In the method of FIG. 4, however, snoops are not blocked until a write is committed. Once a write is committed and started, snoops to its cache line are blocked until the write is completed.

If a cache line is snooped (block 440), the ownership of cache lines later than an invalid cache line are revoked (block 445), and control is returned to block 430. At block 420, ownership of all invalid cache lines is requested.

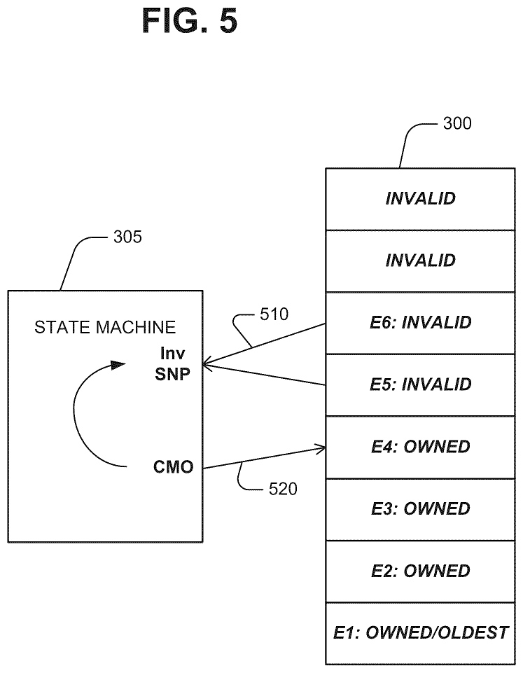

FIG. 5 shows how revoking the ownership resolves the deadlock of FIG. 3. When block 440 is entered, the cache line of the fourth write is invalid. At block 440, ownership of the cache lines of the fifth and sixth writes are revoked. This allows a snoop response (510) to be sent back to the state machine 305. This, in turn, allows the CMO for the cache line of the fourth write to progress (520). Ownership of the cache line of the fourth write is now granted. At block 450, CMOs are now issued to regain ownership of the cache lines of the fifth and sixth writes.

In some embodiments, the electronic system 100 may be a system-on-chip (SoC) that includes the NoC 140. However, an electronic system herein is not limited to a NoC.

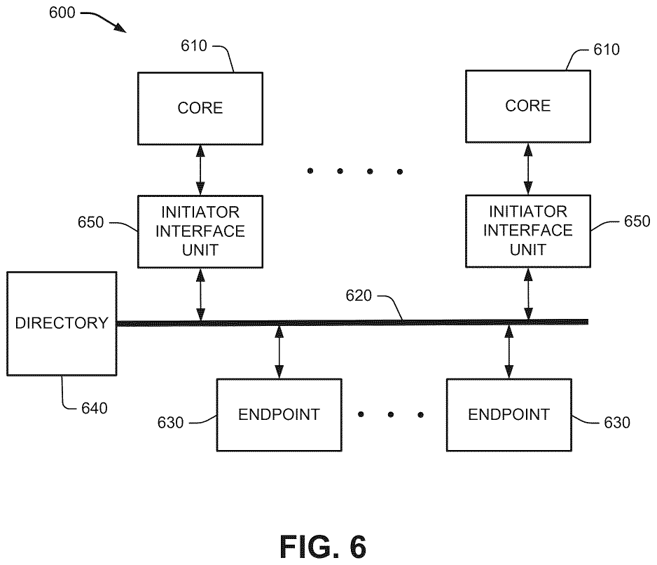

Reference to FIG. 6. An electronic system 600 includes multiple cores 610, an interconnect 620, and one or more endpoints 630 connected to the interconnect 620. The interconnect 620 may include a data bus.

The electronic system 600 further includes a directory 640 and a plurality of initiator interface units 650. The directory 640 and initiator interface units 650 maintain cache coherence as described herein. Each initiator interface unit 650 is configured to receive request transactions from a corresponding initiator and send requests for ownership to the directory 640. The directory 640 is configured to grant ownership to the cache lines, and commit each write that is oldest and whose cache line has acquired ownership.

In some embodiments of the electronic system 600, the initiator interface units 650 may include ethernet cards, and the cores 610 may include racks of computers. The directory 640 may be a programmed microprocessor or it may be a specialized chip that oversees the transportation of large amounts of data.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Various examples are methods that use the behavior of either or a combination of machines. Method examples are complete wherever in the world most constituent steps occur. For example, IP elements or units include: processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

What is claimed is:

1. In an electronic system including an interconnect for a plurality of cores, a directory-based cache coherence method comprising:
receiving a request transaction including a plurality of writes;
sending a request for ownership of a window of cache lines corresponding to the plurality of writes;
granting ownership to the cache lines without regard for order; and
committing a write that is oldest once ownership has been granted to its corresponding cache line.

2. The method of claim 1, wherein ownership is requested by a cache maintenance operation, and the write is a write-back.

3. The method of claim 1, wherein once the committed write has started, snoops to the corresponding cache line are blocked until the committed write has been completed.

4. The method of claim 1, wherein when a snoop is received and when the cache line of a given write is waiting for ownership, the ownership of all cache lines of writes after the given write is revoked.

5. The method of claim 4, wherein ownership is once again requested for those cache lines that had their ownership revoked.

6. The method of claim 1, further comprising releasing ownership of the window of cache lines after write data becomes visible downstream.

7. The method of claim 1, wherein the request transaction is received and the request for ownership is sent by an interface unit; and wherein ownership is granted and the oldest write is committed by a directory.

8. An electronic system comprising:
a plurality of initiators;
an interconnect;
a plurality of interface units, each interface unit configured to receive request transactions from a corresponding initiator and send requests for ownership of windows of cache lines corresponding to writes in the request transactions; and
a directory for maintaining cache coherence, the directory configured to grant ownership to the cache lines;
wherein each write that is oldest and whose cache line has acquired ownership is committed.

9. The system of claim 8, wherein the directory, the interface units, and the interconnect are elements of a network-on-chip.

10. The system of claim 8, wherein each interface unit is configured to request ownership via cache maintenance operations, and perform the writes as write-backs.

11. The system of claim 8, wherein once a committed write has started, snoops to the corresponding cache line are blocked until the committed write has been completed.

12. The system of claim 11, wherein when a snoop is received and when the cache line of a given write is waiting for ownership, the directory is configured to revoke ownership of the cache line of any write after the given write.

13. The system of claim 12, wherein an interface unit is configured to re-request ownership of cache lines that had their ownership revoked.

14. The system of claim 8, wherein the directory is further configured to release ownership of the window of cache lines after write data becomes visible downstream.

15. A network-on-chip comprising:
a plurality of initiator network interface units; and
a directory;
wherein each initiator interface is configured to receive request transactions and send requests for ownership of windows of cache lines corresponding to writes in the request transactions;
wherein the directory is configured to grant ownership to the cache lines without regard for order; and
wherein each write that is oldest and whose cache line has acquired ownership is committed.

16. The network-on-chip of claim 15, wherein each initiator network interface unit is configured to request ownership via cache maintenance operations, and perform the writes as write-backs.

17. The network-on-chip of claim 15, wherein once a committed write has started, snoops to the corresponding cache line are blocked until the committed write has been completed.

18. The network-on-chip of claim 15, wherein when a snoop is received and when the cache line of a given write is waiting for ownership, the directory is configured to revoke ownership of the cache line of any write after the given write.

19. The network-on-chip of claim 18, wherein each initiator network interface unit is configured to re-request ownership of cache lines that had their ownership revoked.

20. The network-on-chip of claim 15, wherein the directory is further configured to release ownership of the window of cache lines after write data becomes visible downstream.
